(19) United States
(12) Patent Application Publication
(10) Pub. No.: US 2026/0147162 A1
(43) Pub. Date: May 28, 2026

(54) MODULAR DUST PLUG ASSEMBLIES FOR FIBER OPTIC MULTIPORT TERMINALS

(71) Applicant: CORNING RESEARCH & DEVELOPMENT CORPORATION, Corning, NY (US)

(72) Inventor: Joel Christopher Rosson, Hickory, NC (US)

(21) Appl. No.: 18/959,824

(22) Filed: Nov. 26, 2024

(51) Int. Cl. G02B 6/38

(52) U.S. Cl. CPC G02B 6/3849; G02B 6/3831; G02B 6/3893

(57) ABSTRACT

In one embodiment, a dust plug assembly for a fiber optic multiport terminal includes a dust plug having an insertion end and a barb at an end opposite the insertion end. The dust plug assembly further includes a lanyard having a flange with a face and an opening at the face that includes a geometry that corresponding with a geometry of the dust plug. The opening leads to a passageway within the lanyard that is operable to receive and lock the barb of the dust plug.

### FIELD

The present application is directed to an improved dust plug for use with multiport terminal. The dust plug comprises a dust plug with an insertion end for cooperating with a port of a multiport terminal and an opposite end having a barb along with a lanyard.

### BACKGROUND

Optical fiber is increasingly being used for a variety of applications, including but not limited to broadband voice, video, and data transmission. As bandwidth demands increase optical fiber is migrating deeper into communication networks such as in fiber to the premises applications such as FTTx, 5G, and the like. As optical fiber extends deeper into communication networks there exists a need for building more complex and flexible fiber optic networks in a quick and easy manner.

Fiber optic connectors are often inserted into a receiving port, such as a port of a multiport terminal. Oftentimes, at least some of the ports of the multiport terminal are unused. For example, there may not be enough subscribers in the area to fully use all of the ports on the multiport terminal. In this case, a dust plug should be used to seal the port to prevent dust, debris and moisture from entering the port. Multiport terminals are often located in rugged environments, such as within the ground or mounted aerially on a pole. Thus, the unused ports should be sealed from the environment.

The style and configuration of the dust plug may vary depending on the application. For example, some dust plug configurations enable the dust plugs to be attached to a housing of the multiport terminal to prevent them from getting lost. Other dust plugs are not attached to the housing and thus have a different configuration. Any number of configurations of dust plugs may be used. However, manufacturing and storing multiple dust plug styles requires multiple stock keeping units (SKU), which adds costs for inventory purposes. Additionally, a craftsman in the field may not be carrying a type of dust plug that is needed, which would necessitate a return trip to the multiport terminal.

Consequently, there exists an unresolved need for dust plug assemblies having a dust plug that is common to many dust plug configurations.

### BRIEF SUMMARY

In one embodiment, a dust plug assembly for a fiber optic multiport terminal includes a dust plug having an insertion end and a barb at an end opposite the insertion end. The dust plug assembly further includes a lanyard having a flange with a face and an opening at the face that includes a geometry that corresponds with a geometry of the dust plug. The opening leads to a passageway within the lanyard that is operable to receive and lock the barb of the dust plug.

In another embodiment, a fiber optic multiport assembly includes a fiber optic multiport having a plurality of ports, and at least one dust plug assembly disposed within at least one port of the plurality of ports. The at least one dust plug assembly includes a dust plug having an insertion end and a barb at an end opposite the insertion end, wherein the barb includes a geometry. The dust plug assembly further includes a lanyard having a flange with a face and an opening that includes a corresponding geometry that corresponds with the geometry of the dust plug. The opening leads to a passageway within the lanyard that is operable to receive and lock the barb of the dust plug.

In another embodiment, a dust plug for a fiber optic multiport terminal includes an insertion end and a barb at an end opposite the insertion end, wherein the barb includes a geometry. The barb is operable to lock a lanyard that includes a flange having a face and an opening with a corresponding geometry that corresponds with the geometry of the dust plug. The opening leads to a passageway within the lanyard that is operable to receive and lock the barb of the dust plug.

In another embodiment, a lanyard for locking to a dust plug for a fiber optic multiport terminal includes a flange having a face and an opening at the face, wherein the opening leads to a passageway within the lanyard that is operable to receive a barb of the dust plug having a geometry, and lock the lanyard to the barb of the dust plug.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example fiber optic multiport terminal assembly according to one or more embodiments described and illustrated herein.

FIG. 2 illustrates a perspective view of an example dust plug assembly according to one or more embodiments described and illustrated herein.

FIG. 3 illustrates an exploded perspective view of the example dust plug assembly of FIG. 2 according to one or more embodiments described and illustrated herein.

FIG. 4A illustrates a perspective view of an example dust plug according to one or more embodiments described and illustrated herein.

FIG. 4B illustrates a perspective view of an example lanyard according to one or more embodiments described and illustrated herein.

FIG. 5 illustrates a cross-sectional view of the dust plug assembly of FIG. 2 according to one or more embodiments described and illustrated herein.

FIG. 6 illustrates a cross-sectional view of an example fiber optic multiport assembly with a dust plug assembly inserted into a port according to one or more embodiments described and illustrated herein.

### DETAILED DESCRIPTION

References will now be made in detail to the embodiments of the disclosure, examples of which are illustrated in the accompanying drawings. Whenever possible, like reference numbers will be used to refer to like components or parts.

Embodiments of the present disclosure are directed to dust plug assemblies for multiport terminals used in optical communication networks. Multiport terminals enable the splitting of one or more input optical signals from a branch line into a plurality of outputs provided at a plurality of output ports that are operable to receive optical connectors of drop cables that are routed to individual subscribers, such as homes and businesses.

Dust plugs are used to seal unused ports of the multiport assembly. As described in more detail below, dust plugs include one or more sealing members that environmentally seal the port to prevent dust, debris and moisture from entering therein. When a new subscriber joins the optical communication network, a dust plug is removed from an individual port and a connector of a drop cable that is run to the new subscriber is inserted into the open port.

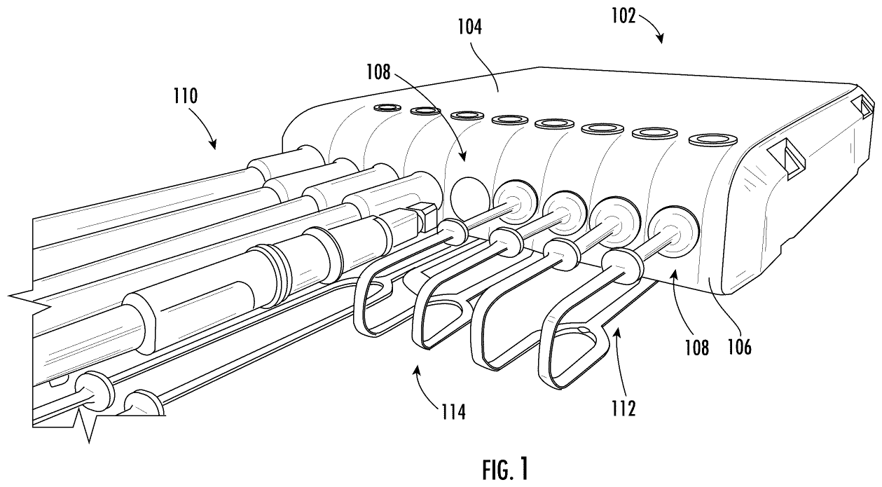

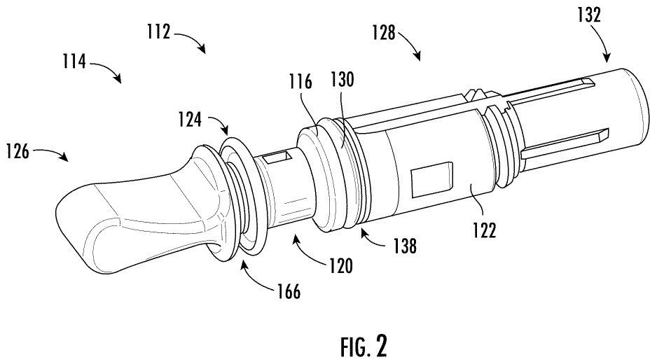

As described in more detail below, dust plugs may come in a variety of configurations. In one style (see FIG. 1), the dust plug includes a lanyard in the form of a flexible looping pull tab that is coupled to a surface of the housing of the multiport terminal to prevent the dust plug from getting lost when it is not in use. In other configurations, the dust plug has a lanyard that is configured as a finger tab (see FIG. 2) that is not further coupled to a housing of the multiport terminal. Such a dust plug may be used in cases where space is constrained, for example.

However, having different dust plug configurations requires different SKUs for the individual dust plug configurations, which increases costs and complicates the task of installing dust plugs for the craftsman as the craftsman may not have the desired dust plug on-hand when needed. Embodiments of the present disclosure provide for modular dust plug assemblies having a common dust plug that attaches to many different lanyard configurations, thus increasing flexibility in inventory management as well as installation in the field by the craftsman.

Various embodiments of multiport terminal assemblies, dust plug assemblies, dust plugs, and lanyards are described in detail below.

Referring now to FIG. 1, an example multiport assembly 102 is illustrated in a perspective view. The example multiport assembly 102 includes a fiber optic multiport terminal 104 having a plurality of ports 108 at a front end 106, a plurality of fiber optic connectors 110 and a plurality of dust plug assemblies 112. The fiber optic multiport terminal 104 is configured as an optical component within a fiber optic network, such as an optical splitter that splits one or more input optical signals into a plurality of output optical signals that are provided at the plurality of ports 108 for routing to a plurality of subscribers, such as homes, businesses, and other entities. Although the example fiber optic multiport terminal 104 has one input (the far left port 108) and eight output ports 108, any number of input ports and output ports may be provided. As another example, multiple rows of ports 108 may be provided at the 106 of the fiber optic multiport terminal 104. The fiber optic multiport terminal 104 may be an Evolv® multiport terminal sold by Corning Optical Communications of Charlotte, NC, for example. However, the dust plug assemblies may be utilized in other types of multiport terminals.

The dust plug assemblies 112 shown in FIG. 1 further have a lanyard 114 that enable a user to pull the dust plug assembly out of a respective port 108. In the illustrated example, the lanyard 114 has an actuation portion configured as a flexible strap that is connected to two individual dust plugs as well as a surface of the housing of the fiber optic multiport terminal 104. This lanyard 114 style allows the dust plug to remain connected to the housing of the fiber optic multiport terminal 104 even when it is not inserted into a port to prevent it from being lost, and allowing it to be readily available if needed in the future. In other embodiments, the lanyard 114 is a flexible strap that is only connected to one dust plug.

As described above, the dust plug assemblies 112 described herein are modular in design to enable the use of different lanyard configurations with a common dust plug.

Referring now to FIG. 2, an individual example dust plug assembly 112 is illustrated in a perspective view. The example dust plug assembly 112 comprises a sealing member 130, a dust plug 128, and a lanyard 114 that is coupled to the dust plug 128. The dust plug 128 includes a body 122 having an insertion end 132 that is configured to be inserted into an empty port 108 of a fiber optic multiport terminal 104. The body 122 of the dust plug 128 has an outer diameter that corresponds to the inner diameter of a port 108 of the fiber optic multiport terminal 104 such that it prevents foreign substances (e.g., dust, debris and moisture) from entering the port 108 and damaging the fiber optic multiport terminal 104.

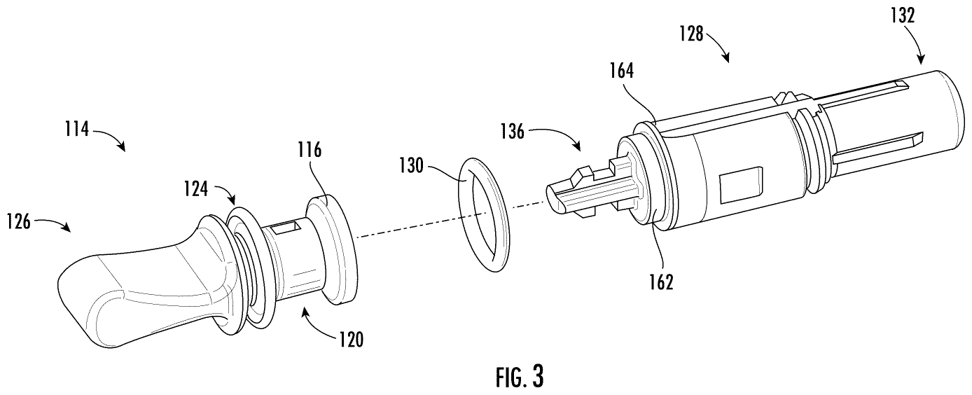

The example lanyard 114 generally comprises a flange 116, a central body 120, a sealing flap 124, and an actuation portion 126. The flange 116 and a circumferential end surface 164 of the body 122 (FIG. 3) of the dust plug 128 define a sealing groove 138. The sealing member 130, which may be configured as an O-ring, is positioned within the sealing groove 138 defined by the flange 116 and the body 122. The sealing member 130 may be made of an elastomer that can provide a seal between an inner surface of the port 108 and an outer surface of the dust plug 128. In some embodiments, a lubricant is provided on the sealing member 130 to lower the friction between the sealing member 130 and the inner surface of the port 108 to enable the dust plug assembly 112 to be repeatedly inserted and removed from a port 108 of a fiber optic multiport terminal 104. In some embodiments, the sealing member 130 is fabricated from a elastomeric silicone and further coated with polytetrafluoroethylene (PTFE). The low coefficient of friction provided by the PTFE coating 130 allows for repeated insertion and removal of a fiber optic connector into and from a port without additional lubricant.

In the illustrated example, the central body 120 has a diameter that is less than the diameter of the flange 116 and is disposed between the flange 116 and the sealing flap 124. The smaller diameter for the central body 120 allows space for the sealing flap 124 to possess a taper in a direction away from the insertion end 132, as well as for the sealing flap 124 to deform and move in a direction toward the insertion end 132 when the dust plug assembly 112 is pulled out of a port 108. The lanyard 114 is fabricated from an elastomer, such as a thermoplastic elastomer, such that it flexible and the sealing flap 124 is capable of being deformed and act as a secondary sealing member at the opening of the port 108. The tapered shape of the sealing flap 124 (tapered in a direction away from the flange 116) allows easy insertion of the sealing flap 124 into the port 108. When the dust plug assembly 112 is inserted into a port 108, the sealing flap 124 is compressed and deformed backward in a direction away from the flange 116 into a gap 166 between the sealing flap 124 and a portion of the actuation portion 126. The sealing flap 124 provides the benefit of an environmental seal proximate at the opening of the port 108 to prevent foreign substances (e.g., dust, debris and moisture) from entering and building up within the port 108.

The lanyard 114 of the present example has an actuation portion 126 that is not a flexible strap as shown in FIG. 1 but rather a finger pull that is not attached to the housing of the multiport assembly 102. The shape of the actuation portion 126 is such that a user can grasp it to pull the dust plug assembly 112 out of a port 108 and insert the dust plug assembly 112 into a port 108. In the illustrated embodiment, the thickness of the actuation portion 126 configured as a finger pull increases in a direction away from the flange 116.

As stated above, the lanyard 114 and the dust plug 128 are two separate components that are connected together to provide a dust plug assembly 112 having a customized lanyard 114. FIG. 3 is an exploded perspective view of the dust plug 128 illustrated in FIG. 2. The dust plug 128 has a seat 162 that extends from a surface 164 of the body 122 such that the seat 162 is between a barb 136 and the surface 164. The diameter of the seat 162 is less than the diameter of the body 122 to provide the surface 164. The seat 162 provides a surface 164 for the sealing member 130 to be positioned on when it is disposed within the sealing groove 138 defined by the flange 116 of the lanyard 114 and the surface 164 of the dust plug 128.

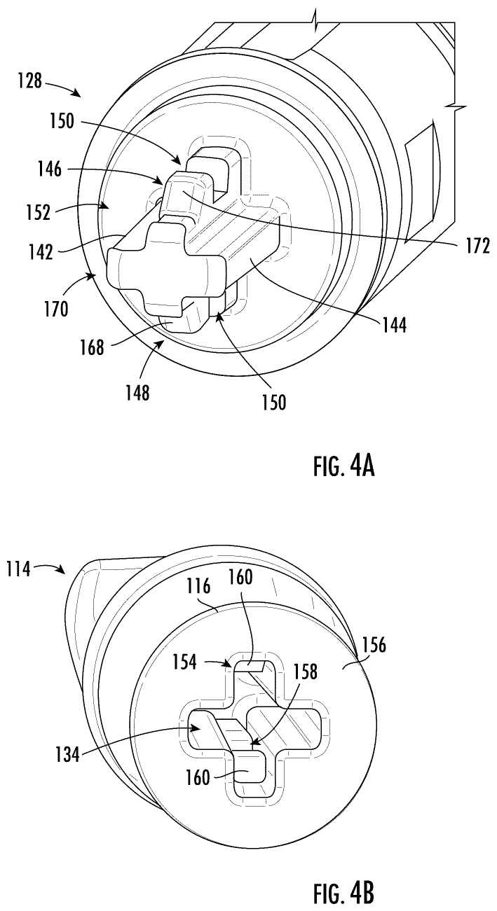

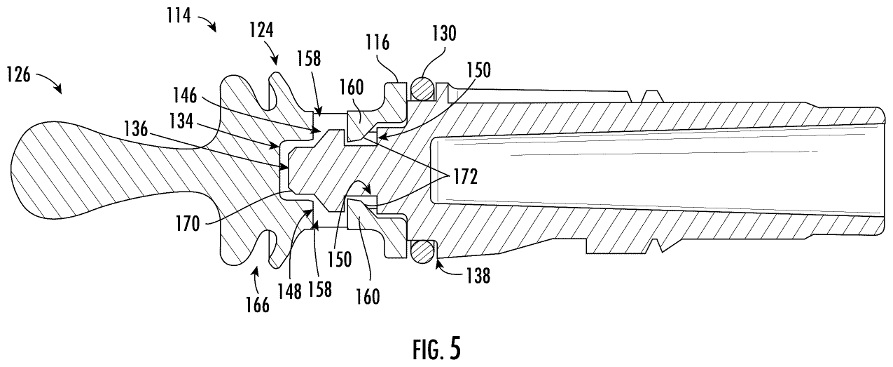

The barb 136 that extends from the seat 162 is shaped and used to lock the lanyard 114 to the dust plug 128. FIG. 4A illustrates a close-up, perspective view of the barb 136 of the dust plug 128 shown by FIG. 2 and FIG. 3. The barb 136 is shaped and configured to both lock the lanyard 114 to the dust plug 128 and prevent rotation of the lanyard 114 with respect to the dust plug 128. The example barb 136 shown in FIG. 4A has a geometry that is a cross, which prevents rotation of the lanyard 114 with respect to the dust plug 128. More specifically, the barb 136 comprises a first ridge 142 and the second ridge 144 that are both within a first common plane, and a third ridge 146 and a fourth ridge 148 that are in a second common plane that is transverse to the first common plane. The first ridge 142 and the second ridge 144 work to prevent rotation of the lanyard 114, as described in more detail below. The third ridge 146 and the fourth ridge 148 each include a notch 150 that is used to engage catch 160 within the lanyard 114 (see FIG. 4B and FIG. 5) to lock the lanyard 114 to the dust plug 128.

The front end or “nose” of the barb 136 is tapered to ease and guide insertion of the barb 136 into the opening 154 and passageway 134 of the lanyard 114 (FIG. 4B). Additionally, the third ridge 146 and the fourth ridge 148 include have a tapered surface 168 to ease and guide insertion of the barb 136 into the opening 154 and passageway 134 of the lanyard 114.

Referring now to FIG. 4B, the flange 116 of the lanyard 114 is illustrated in a rear perspective view. The flange 116 includes an opening 154 at a face 156 having a cross geometry corresponding to the cross geometry of the barb 136 so that the barb 136 may be inserted into the opening 154. The opening 154 leads to a passageway 134 into which the barb 136 is inserted and resides to lock the lanyard 114 to the dust plug 128. The passageway 134 has a cross geometry in cross-section that corresponds to the geometry of the opening 154 and the barb 136. The passageway 134 further includes two catches 160 that are used to lock the lanyard 114 to the barb 136 and thus the dust plug 128, as described below.

The assembler in the factory may carry an inventory of different lanyard styles as well as a plurality of individual dust plugs 128. Depending on the needs, the assembler may select a lanyard 114 of a certain lanyard style and insert the barb 136 of a dust plug 128 into the opening 154 of the lanyard 114 to attach the lanyard 114 dust plug 128.

FIG. 5 illustrates the lanyard 114 mated to the dust plug 128label 128 on FIG. 5 in a cross-sectional view. The third ridge 146 and the fourth ridge 148 each have a tapered surface 168. Similarly, the catches 160 within the passageway 134 also have tapered surface 172. When the barb 136 is interested into the passageway 134, the tapered surfaces 168 of the third ridge 146 and the fourth ridge 148 contact and slide along the tapered surfaces 172 of the catches 160, causing the catches 160 to deflect outwardly away from a longitudinal axis of the passageway 134. The catches 160 continue to deflect until the catches 160 are beyond the tapered surfaces 168 and within the notches 150 within the third ridge 146 and the fourth ridge 148. The catches 160 then inwardly move to their nominal position such that they are present within the notches 150. Placement of the catches 160 of the lanyard 114 within the notches 150 of the barb 136 prevent the lanyard 114 from being separated from the dust plug 128 by a pulling force. In this manner, the lanyard 114 is locked to the dust plug 128.

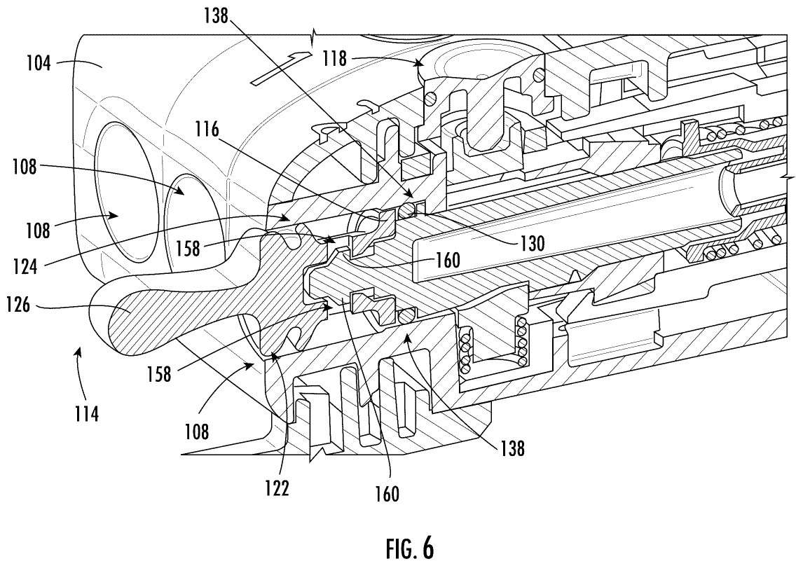

FIG. 6 is a cutaway perspective view of a dust plug assembly 112 inserted into port 108 of a fiber optic multiport terminal 104. The sealing member 130 provides a primary seal that is deep within the port 108. The sealing flap 124 provides a secondary seal that is proximate the opening of the port 108 and thus a seal that is not as deep within the port 108 as the primary seal. The sealing flap 124 can prevent foreign substances from entering and residing in the port 108 between the opening and the primary seal provided by the sealing member 130.

The dust plug assembly 112 may be engaged within the port 108 of the fiber optic multiport terminal 104 by a snap engagement, such as provided by the Evolv® multiport terminal. To remove the dust plug assembly 112, the user presses the button 118 on fiber optic multiport terminal 104 of the corresponding port 108 and pulls the dust plug assembly 112 out.

It should now be understood that embodiments of the present disclosure are directed to modular dust plug assemblies having a dust plug and a lanyard that is attachable to the dust plug. The modular approach allows flexibility in selecting a lanyard style that is most appropriate for the particular application, and allows for the lanyard style of the dust plug assembly to be easily changed. Additionally the lanyards described herein provide a secondary seal in the form of a sealing flap that seals the opening of a port to a fiber optic multiport terminal, further preventing foreign substances from entering the port and the enclosure of the fiber optic multiport terminal.

It is noted that recitations herein of a component of the embodiments being “configured” in a particular way, “configured” to embody a particular property, or function in a particular manner, are structural recitations as opposed to recitations of intended use. More specifically, the references herein to the manner in which a component is “configured” denotes an existing physical condition of the component and, as such, is to be taken as a definite recitation of the structural characteristics of the component.

It is noted that one or more of the following claims utilize the term “wherein” as a transitional phrase. For the purposes of defining the embodiments of the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

Although the disclosure has been illustrated and described herein with reference to explanatory embodiments and specific examples thereof, it will be readily apparent to those of ordinary skill in the art that other embodiments and examples can perform similar functions and/or achieve like results. For instance, the connection port insert may be configured as individual sleeves that are inserted into a passageway of a device, thereby allowing the selection of different configurations of connector ports for a device to tailor the device to the desired external connector. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

1. A dust plug assembly for a fiber optic multiport terminal, the dust plug assembly comprising:
a dust plug comprising an insertion end and a barb at an end opposite the insertion end, wherein the barb comprises a geometry; and
a lanyard comprising a flange having a face and an opening comprising a corresponding geometry that corresponds with the geometry of the dust plug, wherein the opening leads to a passageway within the lanyard that is operable to receive and lock the barb of the dust plug.

2. The dust plug assembly of claim 1, wherein the geometry of the barb comprises a cross.

3. The dust plug assembly of claim 2, wherein the barb comprises a first flange, a second flange, a third flange and a fourth flange.

4. The dust plug assembly of claim 3, wherein the third flange and the fourth flange each comprises a notch.

5. The dust plug assembly of claim 4, wherein the passageway of the lanyard comprises a first recess, a second recess, a first catch and a second catch.

6. The dust plug assembly of claim 5, wherein when the barb is inserted into the passageway, a portion of the first flange and the second flange is disposed within the first recess and the second recess, respectively, and the first catch and the second catch is disposed within the notch of the third flange and the fourth flange, respectively.

7. The dust plug assembly of claim 1, wherein the lanyard further comprises a sealing flap.

8. The dust plug assembly of claim 1, wherein the dust plug further comprises a seat proximate the barb and extending from a body, and the flange, the seat and the body define a sealing groove.

9. The dust plug assembly of claim 8, further comprising a sealing member disposed within the sealing groove.

10. The dust plug assembly of claim 1, wherein the lanyard further comprises an actuation portion.

11. A fiber optic multiport assembly comprising:
a fiber optic multiport comprising a plurality of ports;
at least one dust plug assembly disposed within at least one port of the plurality of ports, the at least one dust plug assembly comprising:
a dust plug comprising an insertion end and a barb at an end opposite the insertion end, wherein the barb comprises a geometry; and
a lanyard comprising a flange having a face and an opening comprising a corresponding geometry that corresponds with the geometry of the dust plug, wherein the opening leads to a passageway within the lanyard that is operable to receive and lock the barb of the dust plug.

12. The fiber optic multiport assembly of claim 11, wherein the geometry of the barb comprises a cross.

13. The fiber optic multiport assembly of claim 12, wherein the barb comprises a first flange, a second flange, a third flange and a fourth flange.

14. The fiber optic multiport assembly of claim 13, wherein the third flange and the fourth flange each comprise a notch.

15. The fiber optic multiport assembly of claim 14, wherein the passageway of the lanyard comprises a first recess, a second recess, a first catch and a second catch.

16. The fiber optic multiport assembly of claim 15, wherein when the barb is inserted into the passageway, a portion of the first flange and the second flange is disposed within the first recess and the second recess, respectively, and the first catch and the second catch is disposed within the notch of the third flange and the fourth flange, respectively.

17. The fiber optic multiport assembly of claim 11, wherein the lanyard further comprises a sealing flap.

18. The fiber optic multiport assembly of claim 11, wherein the dust plug further comprises a seat proximate the barb and extending from a body, and the flange, the seat and the body define a sealing groove.

19. The fiber optic multiport assembly of claim 18, further comprising a sealing member disposed within the sealing groove.

20. The fiber optic multiport assembly of claim 11, wherein the lanyard further comprises an actuation portion.

21. A dust plug for a fiber optic multiport terminal, the dust plug comprising:
an insertion end and a barb at an end opposite the insertion end, wherein:
the barb comprises a geometry;
the barb is operable to lock a lanyard comprising a flange having a face and an opening comprising a corresponding geometry that corresponds with the geometry of the dust plug; and
the opening leads to a passageway within the lanyard that is operable to receive and lock the barb of the dust plug.

22. The dust plug of claim 21, wherein the geometry of the barb comprises a cross.

23. The dust plug of claim 22, wherein the barb comprises a first flange, a second flange, a third flange and a fourth flange.

24. The dust plug of claim 23, wherein the third flange and the fourth flange each comprise a notch.

25. The dust plug of claim 24, wherein the passageway of the lanyard comprises a first recess, a second recess, a first catch and a second catch.

26. The dust plug of claim 25, wherein when the barb is inserted into the passageway, a portion of the first flange and the second flange is disposed within the first recess and the second recess, respectively, and the first catch and the second catch is disposed within the notch of the third flange and the fourth flange, respectively.

27. A lanyard for locking to a dust plug for a fiber optic multiport terminal, the lanyard comprising a flange having a face and an opening at the face, wherein the opening leads to a passageway within the lanyard that is operable to receive a barb of the dust plug having a geometry, and lock the lanyard to the barb of the dust plug.

28. The lanyard of claim 27, wherein the geometry of the barb comprises a cross.

29. The lanyard of claim 28, wherein the barb comprises a first flange, a second flange, a third flange and a fourth flange.

30. The lanyard of claim 29, wherein the third flange and the fourth flange each comprise a notch.

31. The lanyard of claim 30, wherein the passageway of the lanyard comprises a first recess, a second recess, a first catch and a second catch.

32. The lanyard of claim 31, wherein when the barb is inserted into the passageway, a portion of the first flange and the second flange is disposed within the first recess and the second recess, respectively, and the first catch and the second catch is disposed within the notch of the third flange and the fourth flange, respectively.

33. The lanyard of claim 27, wherein the lanyard further comprises a sealing flap.

34. The lanyard of claim 27, wherein the lanyard further comprises an actuation portion.
